(19) United States
(12) Patent Application Publication
(10) Pub. No.: US 2026/0270217 A1
(43) Pub. Date: Sep. 10, 2026

(54) SYSTEMS, METHODS, AND MEDIA FOR COLLABORATIVE TRANSMISSION OF SENSOR DATA BASED ON INTERNET OF THINGS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Chang SU, Chengdu (CN)

(73) Assignee: CHENGDU QINCHUAN IOT TECHNOLOGY CO., LTD., Chengdu (CN)

(21) Appl. No.: 19/660,202

(22) Filed: Apr. 27, 2026

(30) Foreign Application Priority Data
Apr. 2, 2026 (CN) 202610425592.4

(51) Int. Cl. H04L 47/62; H04L 47/24; H04L 67/12; H04L 69/22

(52) U.S. Cl. CPC H04L 47/6215; H04L 47/24; H04L 69/22; H04L 67/12

(57) ABSTRACT

Provided is a system, a method, and a medium for collaborative transmission of sensor data based on Internet of Things, the system includes a management platform and a perception and control platform including an edge computing device. The management platform is configured to: determine a data type of a data frame according to a header parameter of the data frame; determine a priority of the data frame according to the data type, an expiration time, and an information entropy; determine a bandwidth adjustment parameter according to load data of a channel, backlog data of a priority queue, and the priority of the data frame; and generate a first adjustment instruction according to the bandwidth adjustment parameter, and send the first adjustment instruction to the perception and control platform. The edge computing device is configured to: adjust a transmission bandwidth of the channel based on the first adjustment instruction.

### CROSS-REFERENCE TO RELATED APPLICATIONS

This application claims priority to Chinese Patent Application No. 202610425592.4, filed on Apr. 2, 2026, the contents of which are hereby incorporated by reference to its entirety.

### TECHNICAL FIELD

The present disclosure generally relates to the field of data transmission, and in particular to a system, a method, and a medium for collaborative transmission of sensor data based on Internet of Things.

### BACKGROUND

In existing information systems, high-frequency perception data acquired by sensors and real-time control instructions usually need to be transmitted through a shared physical channel, and a bandwidth of each channel is typically fixed. Because perception data with a huge data volume may preempt limited transmission bandwidth, key control instructions often experience uncontrollable transmission delays due to network congestion.

Therefore, a system and a method for collaborative transmission of sensor data based on the Internet of Things are expected to be provided, which can dynamically isolate and schedule data flows without adding physical channels.

### SUMMARY

One or more embodiments of the present disclosure provide a system for collaborative transmission of sensor data based on Internet of Things, and the system includes a management platform and a perception and control platform. The management platform is configured to: determine a data type of a data frame according to a header parameter of the data frame; determine a priority of the data frame according to the data type, an expiration time, and an information entropy; determine a bandwidth adjustment parameter according to load data of a channel, backlog data of a priority queue, and the priority of the data frame; and generate a first adjustment instruction according to the bandwidth adjustment parameter, and send the first adjustment instruction to the perception and control platform. The perception and control platform includes an edge computing device, and the edge computing device is configured to: adjust a transmission bandwidth of the channel based on the first adjustment instruction.

One or more embodiments of the present disclosure provide a method for collaborative transmission of sensor data based on Internet of Things, the method is implemented based on a management platform, and the method comprises: determining a data type of a data frame according to a header parameter of the data frame; determining a priority of the data frame according to the data type, an expiration time, and an information entropy; determining a bandwidth adjustment parameter according to load data of a channel, backlog data of a priority queue, and the priority of the data frame; generating a first adjustment instruction according to the bandwidth adjustment parameter, and sending the first adjustment instruction to a perception and control platform, wherein the perception and control platform includes an edge computing device; and adjusting a transmission bandwidth of the channel by the edge computing device based on the first adjustment instruction.

One or more embodiments of the present disclosure provide a non-transitory computer-readable storage medium. The storage medium stores computer instructions, and when a computer reads the computer instructions in the storage medium, the computer executes the method for collaborative transmission of sensor data based on Internet of Things.

### BRIEF DESCRIPTION OF THE DRAWINGS

FIG. 1 is a schematic diagram illustrating a platform structure of a system for collaborative transmission of sensor data based on Internet of Things according to some embodiments of the present disclosure;

FIG. 2 is a flowchart illustrating an exemplary process of a method for collaborative transmission of sensor data based on Internet of Things according to some embodiments of the present disclosure;

FIG. 3 is a schematic diagram illustrating a preprocessing operation according to some embodiments of the present disclosure;

FIG. 4 is a flowchart illustrating an exemplary process for determining a bandwidth adjustment parameter according to some embodiments of the present disclosure;

FIG. 5 is a schematic diagram illustrating an effect prediction model according to some embodiments of the present disclosure; and

FIG. 6 is a schematic diagram illustrating a bandwidth prediction model according to some embodiments of the present disclosure.

### DETAILED DESCRIPTION

The drawings to be used in the description of the embodiments are briefly introduced as follows. The drawings do not represent all embodiments.

The terms “system”, “apparatus”, “unit” and/or “module” used in the present disclosure are a method for distinguishing different components, elements, parts, sections or assemblies at different levels. If other words can achieve the same purpose, the words may be replaced by other expressions.

Unless the context clearly indicates an exception, words such as “a”, “an”, “one” and/or “the” are not specifically singular and may also include plural. Generally, the terms “include” and “contain” only suggest including clearly identified steps and elements, and these steps and elements do not constitute an exclusive list. A method or device may also include other steps or elements.

In the embodiments of the present disclosure, when describing operations performed step by step, unless otherwise specified, the order of the steps is adjustable, the steps may be omitted, and other steps may also be included during the operation.

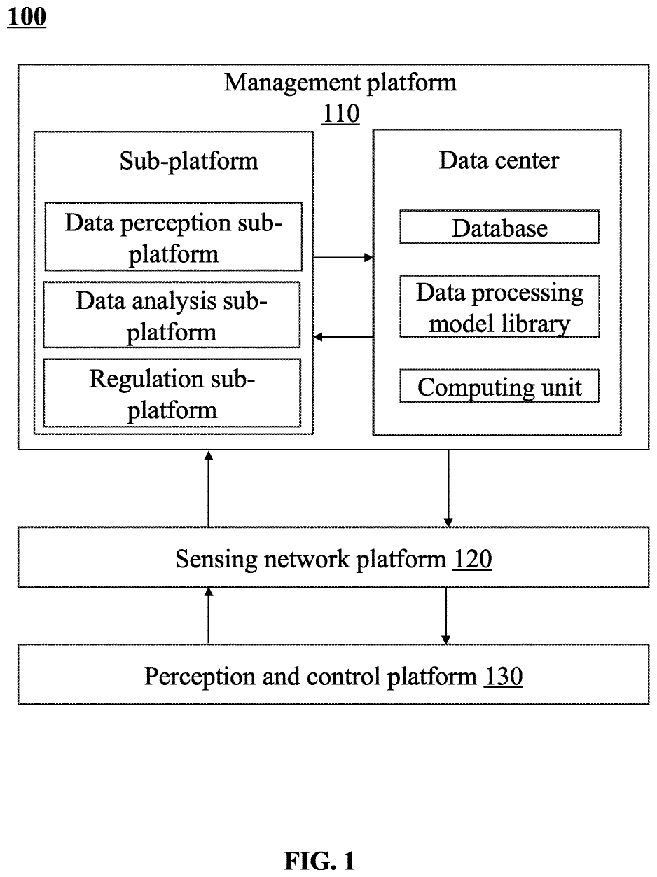

FIG. 1 is a schematic diagram illustrating a platform structure of a system for collaborative transmission of sensor data based on Internet of Things according to some embodiments of the present disclosure.

In some embodiments, as shown in FIG. 1, a system 100 for collaborative transmission of sensor data based on Internet of Things may include a management platform 110, a sensing network platform 120, and a perception and control platform 130.

The management platform 110 refers to a digital monitoring management platform configured to supervise a transmission bandwidth.

In some embodiments, the management platform 110 may be configured in a processor and/or a server. The processor and/or the server may process data and/or information acquired from other platforms. The processor and/or the server may execute program instructions based on the data, the information, and/or a processing result to perform one or more functions described in the present disclosure.

In some embodiments, the management platform 110 includes a sub-platform and a data center that communicate with each other. The sub-platform may process data and/or information acquired from the data center.

In some embodiments, the sub-platform of the management platform 110 includes at least one of a data perception sub-platform, a data analysis sub-platform, and a regulation sub-platform.

The data perception sub-platform refers to a platform configured to receive bandwidth management data. The bandwidth management data refers to data related to bandwidth management, for example, a header parameter of a data frame, a data type, or the like.

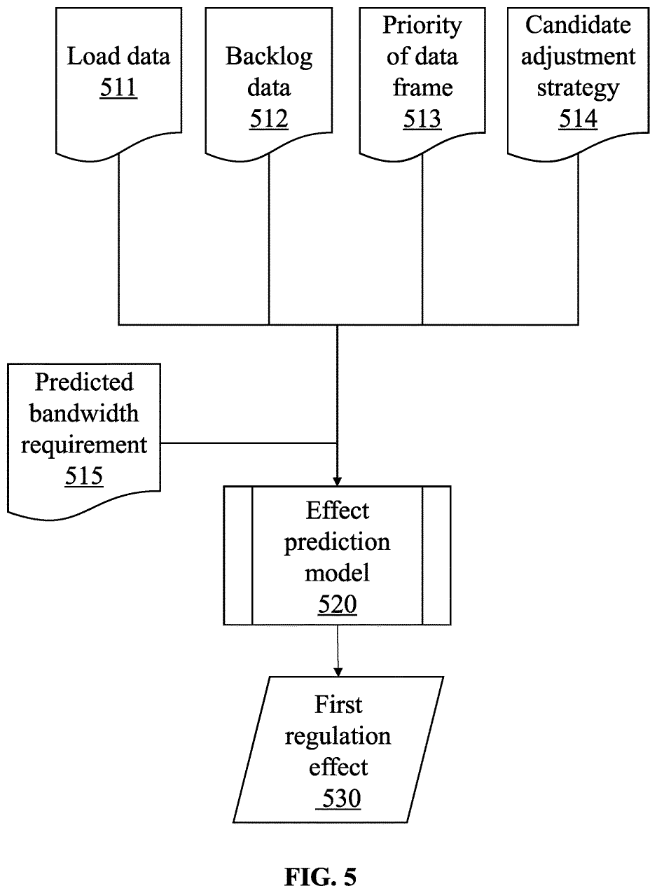

The data analysis sub-platform refers to a management platform configured to evaluate and predict a requirement for adjusting the transmission bandwidth. In some embodiments, the data analysis sub-platform may be configured to determine a predicted bandwidth requirement. More descriptions regarding the predicted bandwidth requirement may be found in FIG. 5 and related descriptions.

The regulation sub-platform refers to a platform configured to prompt adjustment of the transmission bandwidth after determining the requirement for adjusting the transmission bandwidth. In some embodiments, the regulation sub-platform includes access interfaces for mobile phone/computer control terminals, supports visual display, alarm, or the like for axial force/torque data. For example, when a sensing data load is greater than a preset load threshold, the regulation sub-platform may prompt a user to pay attention and perform regulation in a timely manner through a pop-up reminder on a terminal device, a short message notification, or the like.

In some embodiments, the data center includes a database, a data processing model library, and a computing unit.

The database is configured to collect, store, and manage data related to management. For example, the database may be MySQL, PostgreSQL, InfluxDB, Prometheus, or the like.

The data processing model library refers to a collection of data processing models configured to manage data processing. In some embodiments, the data processing models may include an effect prediction model, a bandwidth prediction model, or the like. More descriptions regarding the effect prediction model may be found in FIG. 5 and related descriptions. More descriptions regarding the bandwidth prediction model may be found in FIG. 5 and related descriptions.

The computing unit refers to a functional module configured to perform arithmetic, logic, and other instruction operations. The computing unit may include, but is not limited to, a central processing unit (CPU), or the like.

The sensing network platform 120 refers to a platform configured to perform sensing communication on bandwidth management data, which is configured to realize communication transmission of bidirectional data interaction between the management platform 110 and the perception and control platform 130.

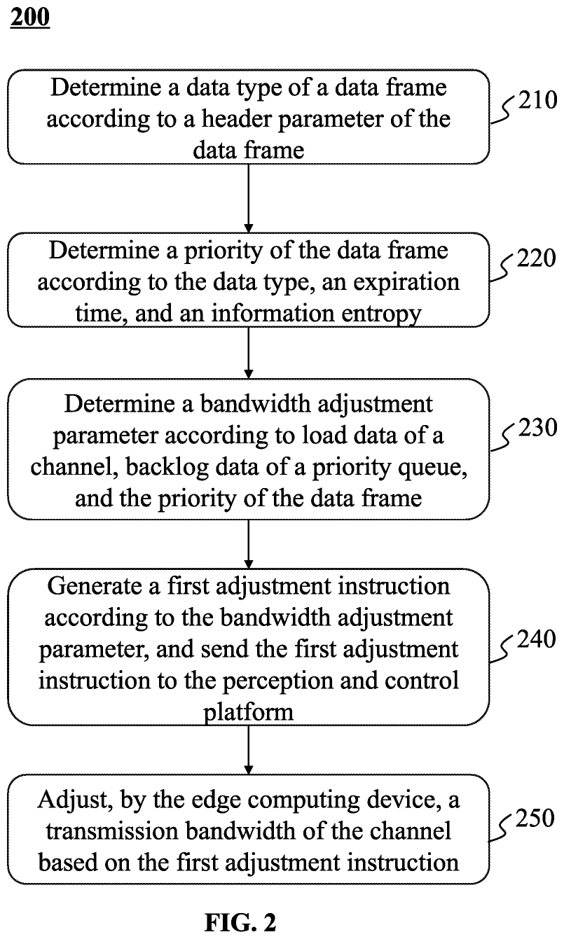

For example, the sensing network platform 120 may include communication devices, servers, various gateway devices, or the like. The bandwidth management data may include a data type of a data frame, a priority, a priority queue, a bandwidth adjustment parameter, or the like. More descriptions regarding the data type of the data frame, the priority, and the priority queue may be found in FIG. 2 and related descriptions.

The perception and control platform 130 refers to an information processing platform for safety supervision of various supervised objects involved in management. A supervised object refers to an object on which management is implemented. In some embodiments, the supervised object may be a controlled device. The controlled device refers to a device whose transmission bandwidth is to be adjusted. For example, the controlled device may be a robotic arm, an environmental auxiliary device, or the like. The environmental auxiliary device may include a temperature and humidity control system. The perception and control platform 130 may include an independent transmission channel, an edge computing device, a sensor, or the like corresponding to each supervised object. The edge computing device may include a gateway, a computer, an intelligent network device, or the like. The sensor may include a humidity sensor, a temperature sensor, a vibrating wire axial force meter, a torque sensor, a multi-dimensional sensor, or the like. A measurement range of the sensor may be determined based on factory settings.

In some embodiments, the sensor deployed on a support shaft or a transmission shaft by the perception and control platform converts a force parameter into a frequency signal. Each sensor integrates a radio frequency chip to form a tree network, a leaf node of the tree network is only responsible for data acquisition, and a routing node has a data relay function.

In some embodiments of the present disclosure, the system 100 for collaborative transmission of sensor data based on Internet of Things can form an information operation closed loop among various functional platforms and operate in a coordinated and regular manner under a unified management of the management platform.

It should be noted that the above descriptions of the system 100 for collaborative transmission of sensor data based on the Internet of Things and its platforms are merely for convenience of description and cannot limit the present disclosure to the scope of the embodiments described herein. It can be understood that for those skilled in the art, after understanding the principles of the system, various platforms may be arbitrarily combined, or subsystems may be constituted to connect with other platforms without departing from this principle.

FIG. 2 is a flowchart illustrating an exemplary process of a method for collaborative transmission of sensor data based on Internet of Things according to some embodiments of the present disclosure. As shown in FIG. 2, a process 200 includes the following operations. In some embodiments, the process 200 may be performed by the management platform in the system for collaborative transmission of sensor data based on the Internet of Things.

In 210, determine a data type of a data frame according to a header parameter of the data frame.

The data frame refers to a basic unit for data transmission. In some embodiments, the data frame includes the header parameter.

The header parameter refers to protocol information in a header of the data frame, for example, a protocol identifier (e.g., EtherCAT, Controller Area Network (CAN), Transmission Control Protocol/Internet Protocol (TCP/IP)), command words (e.g., Command Word, Cmd), a logical address (Address), or the like.

The data type refers to a service attribute of the data frame. In some embodiments, the data type includes a control instruction and perception data.

The control instruction refers to an instruction for controlling a controlled device to perform an action. For example, the control instruction may include a motion control instruction, an environmental adjustment instruction, or the like. The motion control instruction may be used to control a robotic arm to complete physical actions such as handling. The environmental adjustment instruction may be used to control an environmental auxiliary device to adjust temperature or humidity.

The perception data refers to data related to spatial environment perception acquired by the sensor. For example, a sensor configured on the robotic arm may acquire multi-dimensional sensor perception data. The multi-dimensional sensor perception data may include position data of various objects in a three-dimensional map of an environment where the robotic arm is located, which is used to determine obstacles around the robotic arm. A sensor configured on the environmental auxiliary device may acquire environmental monitoring data. The environmental monitoring data includes data such as temperature and humidity of the environment, which is used to determine a real-time status of the environment.

In some embodiments, the management platform may determine the data type of the data frame by querying a first preset table according to the header parameter of the data frame.

The first preset table refers to a mapping relationship table between the header parameter of the data frame and the data type of the data frame.

In some embodiments, the first preset table may include a mapping relationship between different header parameters and data types. The first preset table may be constructed based on empirical presets. For example, in response to determining that a Cmd of the data frame is a write operation (e.g., LWR, APWR) and an Address belongs to a motor register area (e.g., [0x0000-0x0FFF]), a corresponding data type is a control instruction according to the mapping relationship in the first preset table. As another example, in response to determining that the Cmd of the data frame is a read operation (e.g., LRD, APRD) or the Address belongs to a sensor data area (e.g., [0x1000-0xFFFF]), a corresponding data type is perception data according to the mapping relationship in the first preset table.

In 220, determine a priority of the data frame according to the data type, an expiration time, and an information entropy.

The expiration time refers to a time difference between a current moment and an expiration moment.

The expiration moment refers to a moment when the data frame loses a service value or causes a system failure.

The data frame losing the service value refers to the data frame being unable to support system decision-making or a service objective. Merely by way of example, at a moment when an execution of the control instruction is completed, the control instruction loses the service value, and the management platform may determine the moment as the expiration moment of the data frame. As another example, when a difference between a certain moment and a generation moment exceeds a maximum lifetime of the data frame, the management platform may determine the certain time as the expiration moment of the data frame. The maximum lifetime refers to a maximum duration of existence of the data frame. The maximum lifetime may be preset based on experience. For example, a maximum lifetime of the control instruction is 10 ms.

The generation moment refers to a moment when the data frame is generated. In some embodiments, the management platform may obtain a generation timestamp from the header parameter of the data frame and determine the generation timestamp as the generation moment of the data frame.

The data frame causing the system failure refers to a situation where system function failure, crash, or performance degradation is triggered due to an error in the data frame. For example, the data frame causing the system failure may be a situation where a protocol parsing error occurs due to a format error of the data frame. As another example, the data frame causing the system failure may be a situation where a sensor failure occurs due to a content error of the data frame causing data field verification to fail.

The information entropy refers to data used to quantify a deviation degree of a current data frame from historical data.

In some embodiments, the information entropy may be determined based on the system preset. For example, the information entropy of the control instruction is preset to 1. The information entropy of the perception data may be obtained by calculation based on an average value of a plurality of perception data. For example, the information entropy of the perception data satisfies the following formula (1):

$$a 3 = ( \vert b 1 - b 0 \vert ) / c , \qquad ( 1 )$$

where a3 is the information entropy, b1 is a current value, i.e., an average value of perception data acquired within a preset time period for the current data frame, b0 is a previous value, i.e., an average value of perception data acquired within the preset time period for a previous data frame, and c is a physical range, i.e., a difference between a maximum value and a minimum value of a measurement range of a sensor. More descriptions regarding the sensor and the measurement range may be found in FIG. 1 and the related descriptions.

The priority refers to data used to measure an importance level of the data frame. A higher priority indicates a more advanced processing order for the data frame.

In some embodiments, the management platform may perform a normalization processing on an initial priority, an urgency degree, and the information entropy, perform weighted summation on results of the normalization processing, and determine a summation result as the priority.

The initial priority refers to an initial value of the priority of the data frame.

In some embodiments, the initial priority of the data frame may be preset based on experience. For example, an initial priority of the control instruction is 8, and an initial priority of perception data is 2.

The urgency degree refers to an urgency level for processing the data frame. In some embodiments, the urgency degree may be determined based on formula (2):

$$a 2 = ( {t}_{max} - {t}_{now} ) / {t}_{max} , \qquad ( 2 )$$

where a2 is the urgency degree, tₘₐₓ is a maximum value of expiration times among all current data frames, and t_{now} is an expiration time of the data frame currently being calculated. The management platform may obtain expiration times of all data frames and take a maximum value among the expiration times as tₘₐₓ.

In 230, determine a bandwidth adjustment parameter according to load data of a channel, backlog data of a priority queue, and the priority of the data frame.

The channel refers to a logical transmission channel or a physical link between a control sensor and an edge computing device, or between the edge computing device and the management platform.

The load data is data reflecting a physical transmission capability of the channel. For example, the load data may be a current signal-to-noise ratio (SNR) of the channel, a utilization rate of a physical bandwidth, a packet loss rate, etc.

In some embodiments, the management platform may obtain the load data output by the control sensor at an interface between the channel and the sensor. In some embodiments, the management platform may obtain a communication protocol between the platform and a device and determine the load data by parsing the communication protocol.

The priority queue refers to a scheduling queue corresponding to the channel. In some embodiments, the priority queue includes a high-priority queue and a low-priority queue.

The backlog data refers to an amount of data to be processed within the priority queue. For example, the backlog data may be a size of storage space occupied by a data frame waiting to be sent. In some embodiments, the management platform may obtain a queue length of the data frame waiting to be sent by invoking data stored in the data center, and determine the backlog data.

The high-priority queue refers to a priority queue that is processed with priority. In some embodiments, in response to data existing in the high-priority queue, the management platform processes the data in the high-priority queue with priority.

The low-priority queue refers to a priority queue that is processed secondarily. In some embodiments, in response to no data existing in the high-priority queue, or bandwidth of the channel being idle, the management platform processes data in the low-priority queue.

The bandwidth adjustment parameter refers to a parameter for adjusting the transmission bandwidth of the channel. For example, the bandwidth adjustment parameter may be a token generation rate of the channel.

The token refers to a transmission permission of the data frame. The token generation rate refers to a count of tokens added to a token bucket per unit time. The token generation rate is related to a maximum quantity of data frames allowed to pass through the channel per unit time. A higher token generation rate corresponds to a larger maximum quantity of data frames allowed to pass through the channel. The token bucket refers to a data set accommodating tokens. The token bucket has a preset capacity, e.g., the preset capacity may be 100. Adding a token to the token bucket indicates that the data frame is allowed to be transmitted, and the token is consumed when the data frame is transmitted.

In some embodiments, one data frame exists in one channel, and one channel may transmit a plurality of data frames.

In some embodiments, the management platform may determine the bandwidth adjustment parameter based on a plurality of manners.

In some embodiments, the management platform may determine the bandwidth adjustment parameter based on a first vector database according to load data of a plurality of channels, the backlog data of a priority queue, and the priority of the data frame.

In some embodiments, the first vector database includes a plurality of groups of first feature vectors and corresponding first vector labels. For example, the management platform may filter the load data, the backlog data of the priority queue, and the priority of the data frame when the channel satisfies a preset condition within a time period in historical data to construct a plurality of reference feature vectors. The management platform may determine a reference feature vector satisfying the preset condition as a first feature vector, and use a bandwidth adjustment parameter corresponding to the first feature vector as a corresponding first vector label.

In some embodiments, the preset condition may be that a channel corresponding to the reference feature vector maintains fault-free stable operation within a preset time window. The preset time window may be set based on experience. Fault-free stable operation may be no triggering of an abnormal warning.

The abnormal warning refers to a warning indicating abnormal transmission of the channel. In some embodiments, in response to the load data of the channel satisfying a warning condition, the management platform may send the abnormal warning to a management personnel. The warning condition may be set based on experience.

The management platform may construct a first to-be-matched vector based on the load data of each channel, the backlog data of the priority queue, and the priority of the data frame, and retrieve a target vector based on the first to-be-matched vector through the first vector database. In some embodiments, the management platform may determine the target vector based on similarities between the first to-be-matched vector and the plurality of first feature vectors in the first vector database. For example, a first feature vector having a similarity with the first to-be-matched vector satisfying a preset similarity condition is used as a first target vector. The preset similarity condition may be set according to circumstances. For example, the preset similarity condition may be a maximum similarity, or a similarity greater than a first preset similarity threshold, etc. The first preset similarity threshold is set based on manual experience.

In some embodiments, for a first to-be-matched vector corresponding to a channel, if a corresponding first target vector exists in the first vector database, a bandwidth adjustment parameter of the first target vector is determined as the bandwidth adjustment parameter of the channel.

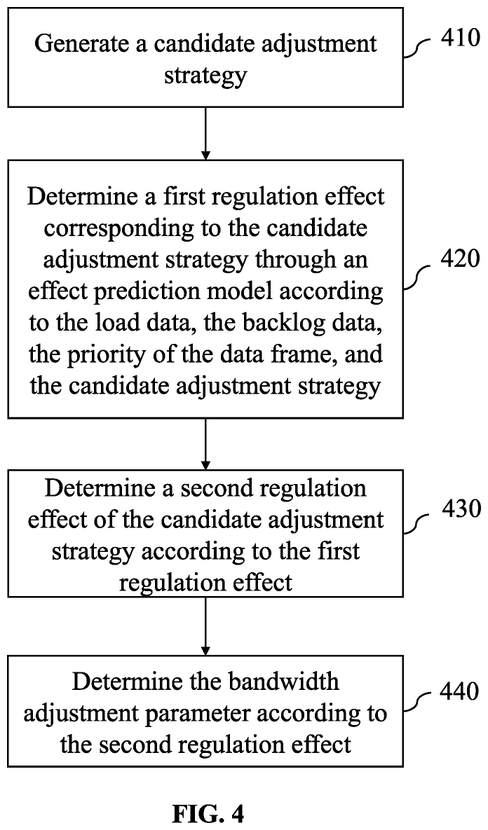

In some embodiments, the management platform determines the bandwidth adjustment parameter based on a candidate adjustment strategy. More descriptions regarding this part herein may be found in FIG. 4 and related descriptions.

In 240, generate a first adjustment instruction according to the bandwidth adjustment parameter, and send the first adjustment instruction to the perception and control platform.

The first adjustment instruction refers to an instruction for adjusting the transmission bandwidth of the channel. In some embodiments, the first adjustment instruction includes adjusting the transmission bandwidth of the channel according to the bandwidth adjustment parameter.

A channel corresponding to the robotic arm carries the motion control instruction and multi-dimensional sensor perception data. A channel corresponding to the environmental auxiliary device carries the environmental adjustment instruction and the environmental monitoring data. Since control instructions and perception data corresponding to different controlled devices are different, bandwidth adjustment parameters corresponding to the different controlled devices are also different.

In some embodiments, the management platform may differentially generate the first adjustment instruction according to bandwidth adjustment parameters of different channels. For example, for the robotic arm, the first adjustment instruction generated by the management platform may adjust a total bandwidth of the channel according to an action stage of the robotic arm to avoid motion delay. As another example, for the environmental auxiliary device, the first adjustment instruction generated by the management platform may maintain or appropriately reduce the total bandwidth of the channel according to network load conditions to ensure smooth operation of key devices.

In some embodiments, the management platform is further configured to: determine an acquisition parameter according to the load data and the backlog data; generate an acquisition instruction according to the acquisition parameter, and send the acquisition instruction to the perception and control platform, the acquisition parameter including a sampling frequency and an upload frequency; and control a sensor to perform data acquisition at the sampling frequency based on the acquisition instruction, and upload acquired data to the edge computing device at the upload frequency.

The acquisition parameter refers to a related parameter for controlling an acquisition work of the sensor. For example, the acquisition parameter may include a sampling frequency and an upload frequency.

The sampling frequency refers to a frequency at which the sensor acquires data.

The upload frequency refers to a frequency at which the sensor uploads data to the edge computing device.

A higher signal-to-noise ratio indicates better signal quality and a more stable channel, allowing a higher sampling frequency and a higher upload frequency. A higher utilization rate and a higher packet loss rate indicate less idle bandwidth of the channel and poorer transmission quality, and a corresponding sampling frequency and a corresponding upload frequency need to be reduced.

The load data may be characterized by a load score. The load score refers to a numerical value for quantifying a load state of the channel. A stronger transmission capability corresponds to a larger load score.

In some embodiments, the management platform may obtain a normalized current signal-to-noise ratio, a bandwidth utilization rate, and a packet loss rate to determine the load score. Because the sampling frequency and the upload frequency are positively correlated with the signal-to-noise ratio and negatively correlated with the utilization rate and the packet loss rate, the management platform may calculate the load score based on formula (3):

$$Load score = k 1 * current signal - to - noise ratio + k 2 * ( 1 - bandwidth utilization rate ) + k 3 * ( 1 - packet loss rate ) , \qquad ( 3 )$$

where k1 is a weight corresponding to a current signal-to-noise ratio; k2 is a weight corresponding to the bandwidth utilization rate; and k3 is a weight corresponding to the packet loss rate.

When the load score is greater than a load threshold score, the management platform may increase the sampling frequency and the upload frequency. The load threshold score may be preset based on experience.

More backlog data corresponds to a lower sampling frequency and a lower upload frequency. In some embodiments, in response to detecting that an amount of backlog data of the priority queue exceeds a maximum backlog amount, the management platform may decrease the sampling frequency and the upload frequency, prioritize processing the backlog data of the priority queue, and prevent buffer overflow. The buffer refers to a collection of priority queues to be processed. A maximum backlog amount may be preset based on experience.

The acquisition instruction refers to an instruction for performing data acquisition.

In some embodiments, the management platform may generate the acquisition instruction according to the acquisition parameter. For example, the acquisition instruction may be to perform data acquisition based on the acquisition parameter.

In some embodiments, the management platform may send the acquisition instruction to the perception and control platform; control the sensor to perform data acquisition at the sampling frequency based on the acquisition instruction, and upload the acquired data to the edge computing device at the upload frequency.

More descriptions regarding the edge computing device may be found in FIG. 1 and related descriptions.

In some embodiments of the present disclosure, by utilizing the load data and combining an backlog situation of the priority queue, source-end adaptive control of the sampling frequency and the upload frequency of the controlled sensor is achieved. The source-end adaptive control can automatically improve data acquisition accuracy to capture more details when channel quality is superior, thereby ensuring data integrity at critical moments. The source-end adaptive control can intelligently reduce the frequency to reduce incoming network traffic during network congestion or queue backlog, thereby effectively preventing continuous traffic peaks from overwhelming a buffer of an edge gateway, avoiding disorderly packet loss caused by buffer overflow, and improving robustness and transmission stability of the system in fluctuating network environments.

In 250, adjust, by the edge computing device, a transmission bandwidth of the channel based on the first adjustment instruction.

The transmission bandwidth refers to a maximum data amount that the channel is able to transmit per unit time.

In some embodiments, after receiving the first adjustment instruction, the edge computing device may dynamically adjust the transmission bandwidth of each channel based on the bandwidth adjustment parameter. For a channel corresponding to a robotic arm, in response to monitoring that the control instruction corresponds to a key action of the robotic arm, the edge computing device may increase the transmission bandwidth of the channel and lock backlog data of a high-priority queue of the channel to ensure that the control instruction passes quickly and avoid motion delay. For a channel of an environmental auxiliary device, the edge computing device may maintain or appropriately reduce the transmission bandwidth of the channel according to a load situation to release network resources and ensure stable operation of other controlled devices.

In some embodiments of the present disclosure, by parsing the header parameter of the data frame to directly distinguish the control instruction from the perception data, and constructing a multi-dimensional priority evaluation system for the data frame based on the expiration time and the information entropy, accurate identification and priority guarantee of key instructions are achieved. Meanwhile, by dynamically adjusting the transmission bandwidth based on channel load and queue backlog situation, the problem of high delay of control instructions and packet loss of perception data caused by traditional static allocation is effectively solved, and real-time performance and stability of an industrial control system are improved.

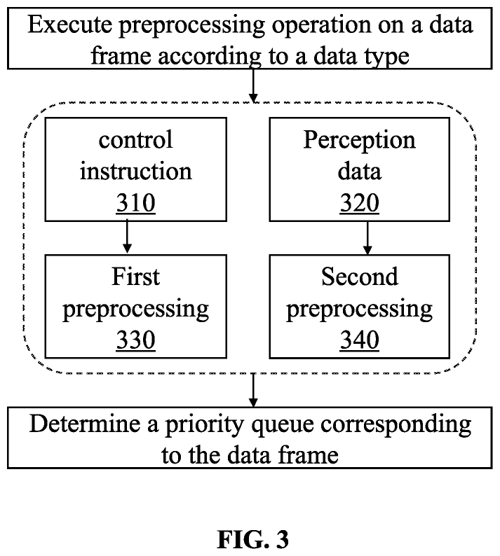

FIG. 3 is a schematic diagram illustrating a preprocessing operation according to some embodiments of the present disclosure.

As shown in FIG. 3, a management platform may execute the preprocessing operation on a data frame according to a data type to determine a priority queue corresponding to the data frame.

The preprocessing operation refers to processing performed on the data frame before transmitting the data frame. For example, the preprocessing operation may include compressing the data frame, placing the data frame into a specified priority queue, etc.

The management platform may compare a priority of the data frame with a preset priority threshold to determine the preprocessing operation corresponding to the data frame. The preset priority threshold is preset based on experience. For example, if the priority of the data frame is less than or equal to the preset priority threshold, the management platform 110 compresses the data frame and places the data frame into a low-priority queue to save bandwidth and reduce redundancy of the data frame. If the priority of the data frame is greater than the preset priority threshold, the management platform 110 places the data frame into a high-priority queue to ensure that the data frame is processed with priority and avoid delay.

In some embodiments, the preprocessing operation includes a first preprocessing 330 and a second preprocessing 340, and the management platform is further configured to: when the data type of the data frame is a control instruction 310, execute the first preprocessing 330 on the data frame; and when the data type of the data frame is perception data 320, execute the second preprocessing 340 on the data frame.

More descriptions regarding the data type may be found in FIG. 2 and related descriptions.

In some embodiments, the first preprocessing includes: bypassing a buffer module and a compression module, so that the data frame directly enters the high-priority queue. The management platform may directly insert the data frame whose data type is the control instruction into the high-priority queue, thereby eliminating waiting time for the data frame to be processed and ensuring that the data frame is processed with priority.

The buffer module refers to a module in the management platform that temporarily stores the data frame to implement data frame shaping and priority scheduling.

The compression module refers to a module in the management platform that performs lossless compression on the data frame.

In some embodiments, the second preprocessing includes: performing lossless compression on the data frame using a preset compression algorithm, so that the data frame enters the low-priority queue. The management platform may perform lossless compression on the data frame whose data type is the perception data using the preset compression algorithm and insert the data frame into the low-priority queue, thereby reducing redundancy of the data frame while ensuring that the data frame does not clog the priority queue.

The preset compression algorithm refers to a compression algorithm determined by preset. For example, the preset compression algorithm may include LZ4, ZSTD, or other compression algorithms.

More descriptions regarding the data frame, the data type, the priority, and the priority queue may be found in FIG. 2 and related descriptions.

In some embodiments of the present disclosure, by performing direct passthrough on the control instruction to ensure millisecond-level response and performing high-ratio compression on the perception data to reduce bandwidth occupation, this “fast-slow separation” processing mechanism, under limited bandwidth resources, both ensures extremely low latency for core data and significantly improves throughput capacity for massive sensing data.

In some embodiments of the present disclosure, by performing preprocessing on the data frame according to the data type, fast transportation of core data frames can be ensured while reducing storage and computational overhead.

FIG. 4 is a flowchart illustrating an exemplary process for determining a bandwidth adjustment parameter according to some embodiments of the present disclosure. As shown in FIG. 4, a process 400 includes the following operations. In some embodiments, the process 400 may be performed by a management platform in a system for collaborative transmission of sensor data based on Internet of Things.

More descriptions regarding the bandwidth adjustment parameter may be found in FIG. 2 and related descriptions.

In 410, generate a candidate adjustment strategy.

The candidate adjustment strategy refers to a set of alternative schemes for the bandwidth adjustment parameter. More descriptions regarding the bandwidth adjustment parameter may be found in FIG. 2 and related descriptions.

In some embodiments, the management platform 110 may generate the candidate adjustment strategy through a random generation function. For example, the management platform 110 may call the random generation function to generate random values of transmission bandwidths of all channels, and use a set of the random values as one candidate adjustment strategy. The above random generation process is repeated K times (K is a preset number of candidate strategies), and K candidate adjustment strategies are obtained.

In some embodiments, the management platform 110 may also generate the candidate adjustment strategy based on load data of all current channels, backlog data of priority queues, and priorities of data frames through a first database. Exemplarily, the management platform 110 may construct a first to-be-matched vector based on the load data of all current channels, the backlog data of the priority queues, and the priorities of the data frames; then obtain, from the first database, first feature vectors whose similarity with the first to-be-matched vector ranks top K (each first feature vector corresponds to the load data of all channels, the backlog data of priority queues, and the priorities of data frames), use each first vector label (each first vector label is a bandwidth adjustment parameter) as one candidate adjustment strategy, and use the first vector labels corresponding to the K first feature vectors as K candidate adjustment strategies. More descriptions regarding determination of a similarity and construction of the first feature vector may be found in FIG. 2 and the related descriptions.

More descriptions regarding the load data, the backlog data of the priority queue, the priority of the data frame, and the first database may be found in FIG. 2 and related descriptions.

In 420, determine a first regulation effect corresponding to the candidate adjustment strategy through an effect prediction model according to the load data, the backlog data, the priority of the data frame, and the candidate adjustment strategy.

The first regulation effect refers to a control effect of the candidate adjustment strategy on each channel, and the first regulation effect is used to evaluate performance of the candidate adjustment strategy on each channel.

In some embodiments, one candidate adjustment strategy corresponds to one first regulation effect.

The first regulation effect may be a sequence composed of control effect values corresponding to a plurality of channels, each element in the sequence may be represented as a value between 0 and 1, and a larger value indicates a better regulation effect. For example, after the management platform 110 applies the candidate adjustment strategy to channel A and channel B, the first regulation effect of the candidate adjustment strategy includes a regulation effect of 0.9 on channel A and a regulation effect of 0.7 on channel B.

In some embodiments, the management platform 110 may determine the first regulation effect corresponding to the candidate adjustment strategy through the effect prediction model according to the load data, the backlog data, the priority of the data frame, and the candidate adjustment strategy.

In some embodiments, the effect prediction model is a machine learning model. For example, the effect prediction model may be any one or a combination of a deep neural network (DNN) or other custom model structures.

As shown in FIG. 5, an input of the effect prediction model 520 may include load data 511, backlog data 512, priority of the data frame 513, and the candidate adjustment strategy 514, and an output of the effect prediction model 520 may include the first regulation effect 530. More descriptions regarding the load data, the backlog data, and the priority of the data frame may be found in corresponding descriptions above.

In some embodiments, the input of the effect prediction model 520 further includes a predicted bandwidth requirement 515 of each channel. The input of the effect prediction model 520 include a predicted bandwidth requirement corresponding to each channel in a first regulation effect.

The predicted bandwidth requirement refers to a required transmission bandwidth for a certain channel to maintain a normal operation within a future time period.

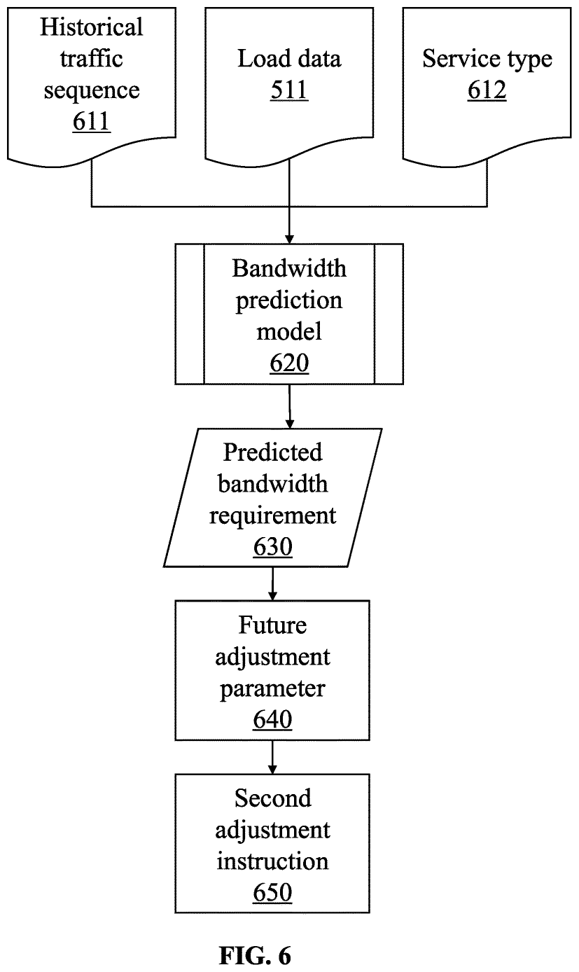

In some embodiments, the management platform 110 may determine the predicted bandwidth requirement in a plurality of ways. For example, the management platform 110 may obtain the predicted bandwidth requirement through the machine learning model. More descriptions regarding how to determine the predicted bandwidth requirement may be found in FIG. 6 and related descriptions.

In some embodiments of the present disclosure, by supplementing the predicted bandwidth requirement of the channel as the input of the effect prediction model, the effect prediction model may further consider a future bandwidth requirement of the channel when predicting the first regulation effect, thereby improving the accuracy of effect prediction for the candidate adjustment strategy.

In some embodiments, the effect prediction model may be obtained by training based on a large number of first training samples with first training labels. The management platform 110 may input a plurality of first training samples with the first training labels into an initial effect prediction model, construct a loss function based on the first training labels and results of the initial effect prediction model, and iteratively update parameters of the initial effect prediction model based on the loss function through a manner such as gradient descent. When the loss function satisfies a preset training condition, a trained effect prediction model is obtained. The preset training condition may include convergence of the loss function, a number of iterations reaching a threshold, etc.

The first training sample and the first training label may be obtained based on historical data. A first training sample may include historical load data, historical backlog data, a priority of a historical data frame, and a historical bandwidth adjustment parameter of a historical period. A first training label may include a first regulation effect of a candidate adjustment strategy corresponding to the first training sample.

In some embodiments, after the management platform 110 adjusts the transmission bandwidth of all channels according to the historical bandwidth adjustment parameter, the management platform 110 evaluates an actual first regulation effect of the historical bandwidth adjustment parameter on each channel according to an idle rate and a transmission delay condition of each channel within a future time period, and determines the actual first regulation effect as the first training label.

The idle rate refers to a proportion of a duration during which a channel is in a no-data-transmission state within a future time period to a total duration, and the idle rate is used to characterize an idle degree of bandwidth resources of the channel. The total duration is a total time length of the future time period.

In some embodiments, the management platform 110 may count a cumulative duration during which the channel is in the no-data-transmission state within the future time period (i.e., an idle duration), and divide the idle duration by the total duration to obtain a ratio, the ratio is the idle rate of the channel.

A transmission delay duration refers to a total time consumed from when data enters a priority queue of the channel to when the data is successfully sent to a target node, and the transmission delay duration is used to measure a transmission response efficiency of the channel. The target node refers to a receiving-end device or a network node that the data is to finally reach after being transmitted through the channel.

In some embodiments, the management platform 110 may record an initial time when the data frame enters a transmission queue of the channel and a completion time when the data frame is successfully sent to the target node, and subtract the initial time from the completion time to obtain a difference, and the difference is the transmission delay duration.

In some embodiments, the management platform 110 may quantify the idle rate and the transmission delay condition into an idle score and a delay score, respectively. The first regulation effect is positively correlated with the idle score and the delay score. Exemplarily, the idle score may be obtained based on formula (4):

$$idle score = 1 - \frac{idle duration}{total duration} . \qquad ( 4 )$$

In some embodiments, the management platform 110 first sets a maximum tolerable delay duration (which may be adjusted according to requirements). The maximum tolerable delay duration refers to the longest delay threshold acceptable to a service when the channel transmits data.

If the transmission delay duration exceeds the maximum tolerable value, the delay score is recorded as 1; otherwise, the delay score may be calculated based on the transmission delay duration and the maximum tolerable delay duration.

For example, the management platform 110 may obtain the delay score based on formula (5):

$$delay score = 1 - \frac{transmission delay duration}{maximum tolerable delay duration} . \qquad ( 5 )$$

The management platform 110 performs weighted fusion processing on the idle score and the delay score of each channel in the first regulation effect, respectively, and a fusion result is a value of each element in a sequence corresponding to the first regulation effect (between 0 and 1). The weighted fusion processing may satisfy formula (6):

$$quantitative value of the first regulation effect = w \times idle score + ( 1 - w ) \times delay score . \qquad ( 6 )$$

In formula (6), w is a weight, which may be preset manually based on experience, and w is between 0 and 1.

A larger value of the first regulation effect indicates a better first regulation effect of the corresponding historical bandwidth adjustment parameter on a certain channel.

In 430, determine a second regulation effect of the candidate adjustment strategy according to the first regulation effect.

The second regulation effect refers to a comprehensive control effect of the candidate adjustment strategy on all channels. For example, the candidate adjustment strategy involves channel A and channel B. After the candidate adjustment strategy is applied, in the first regulation effect corresponding to the candidate adjustment strategy, the first regulation effect on channel A is 0.7, and the first regulation effect on channel B is 0.8. The management platform 110 performs weighted calculation and summation in combination with weight coefficients of the two channels (the weight of channel A and the weight of channel B are both 0.5) to obtain a comprehensive regulation effect corresponding to the candidate adjustment strategy (i.e., the second regulation effect) of 0.75. More descriptions regarding the weight coefficient and how to determine the second regulation effect may be found below and related descriptions.

In some embodiments, the management platform 110 may use the lowest value of the first regulation effect for each candidate adjustment strategy as the second regulation effect of the candidate adjustment strategy. For example, in the first regulation effect corresponding to the candidate adjustment strategy, the first regulation effects of the channel A and the channel B are 0.7 and 0.8, respectively. The management platform 110 uses a first regulation effect of the channel A with a lower value (i.e., 0.7) among the candidate adjustment strategy as the second regulation effect of the candidate adjustment strategy. Using the first regulation effect with the lowest value among the candidate adjustment strategy as the second regulation effect can ensure the lowest limit of an overall regulation effect. More descriptions regarding how to determine the second regulation effect may be found in the following and related descriptions.

In some embodiments, the management platform is further configured to: determine a weight coefficient of the channel according to a state feature and a task feature of a robotic arm corresponding to the channel; and determine the second regulation effect according to the weight coefficient and the first regulation effect.

The state feature of the robotic arm characterizes a key parameter set of a current operating condition of the robotic arm corresponding to each channel. For example, the state feature of the robotic arm may include a position, an attitude, a gripping force, or the like of the robotic arm. State features of different robotic arms may be different, which is not limited herein.

In some embodiments, the state feature of the robotic arm may be obtained by a torque sensor, a position sensor, or the like on the robotic arm corresponding to each channel.

The task feature refers to an attribute of a task currently executed in each channel. For example, the task feature may include a task type, a task stage, or the like. Task features of different robotic arms may be different, which is not limited herein.

In some embodiments, the task feature may be obtained by the management platform 110 directly invoking data stored in the data center.

In some embodiments, the task type may include a high-precision task (e.g., a precision component assembly task, etc.) and a low-precision task (e.g., a common material handling task, etc.).

In some embodiments, the task stage may include an operation stage, an approach stage, an idle stage, or the like.

The operation stage may include a precision welding stage, a high-precision grasping stage, etc. The operation stage requires a high-frequency data feedback from the torque sensor to precisely control a contact force of the robotic arm. Therefore, the operation stage has a high requirement for real-time performance and data integrity of channel transmission.

The approach stage may include a no-load return-to-zero stage, a workpiece approach stage, etc. The approach stage only requires position monitoring of the robotic arm. The approach stage allows the channel to adopt a transmission frequency reduction strategy or a data compression strategy to a certain extent.

The idle stage is a standby state where the robotic arm performs no operation. The idle stage only requires maintaining channel connection through low-frequency heartbeat packets.

The weight coefficient refers to a numerical value characterizing an importance degree of a corresponding channel.

In some embodiments, the management platform 110 may determine the weight coefficient of each channel through a second database according to the state feature and the task feature of the robotic arm corresponding to each channel. For example, the management platform 110 constructs a second to-be-matched vector based on the state feature and the task feature of the robotic arm corresponding to each channel. Subsequently, the management platform 110 retrieves the second database based on the second to-be-matched vector to obtain a second feature vector with a highest similarity to the second to-be-matched vector as a second target vector, and determines a second vector label corresponding to the second target vector as a weight coefficient of a current channel. The management platform 110 repeats the above operation for all channels to obtain weight coefficients corresponding to all channels.

In some embodiments, the management platform 110 determines a similarity by calculating a vector distance between the second to-be-matched vector and each of a plurality of second feature vectors. The vector distance includes a Euclidean distance, etc.

The second database includes the plurality of second feature vectors and a plurality of second vector labels corresponding to the plurality of second feature vectors.

The second feature vector includes the state feature and the task feature of a robotic arm corresponding to a historical channel. The second vector label corresponding to the second feature vector is an actual weight coefficient of a channel corresponding to the second feature vector.

In some embodiments, the management platform 110 may determine a preset time window based on a historical operation log of the system. The preset time window is set manually based on experience. The management platform 110 then filters out, within the preset time window, a target time period corresponding to each channel during which the robotic arm maintains fault-free and stable operation. Fault-free and stable operation refers to no abnormal warning being triggered, or all high-precision tasks being successfully completed. The management platform 110 extracts an actual weight coefficient of each channel during the target time period. The management platform 110 uses the weight coefficient as the second vector label corresponding to the second feature vector during the target time period.

The management platform 110 repeats the above operations of filtering, extracting, and generating the second vector label to collect weight coefficients of channels under a plurality of sets of different combinations of state features and task features of robotic arms to form a sufficient quantity of second vector labels covering a plurality of scenarios in the second database to satisfy the matching requirements of different second feature vectors.

In some embodiments, the management platform 110 may determine the second regulation effect according to the weight coefficient and the first regulation effect. For a single channel, a weighted result of the channel is obtained by multiplying its corresponding weight coefficient by the first regulation effect of the channel, subsequently, a summation calculation is performed on weighted results of all channels to obtain a final summation result, and the final summation result is the second regulation effect.

In some embodiments of the present disclosure, the weight coefficient of the channel is determined by integrating the state feature and the task feature of the robotic arm. The second regulation effect is calculated by combining the weight coefficient and the first regulation effect. The present disclosure can dynamically adapt to channel resource allocation requirements of different operation scenarios, allows channels in key operation stages to obtain resource tilt, ensures stable and non-stuttering communication links, and reduces a risk of robotic arm motion deviation or safety accidents caused by network fluctuations, thereby improving reliability and safety of operation of the system for collaborative transmission of sensor data based on the Internet of Things.

In 440, determine the bandwidth adjustment parameter according to the second regulation effect.

More descriptions regarding the bandwidth adjustment parameter may be found in FIG. 2 and related descriptions.

In some embodiments, the management platform 110 calculates a second regulation effect of each of a plurality of candidate adjustment strategies. The management platform 110 filters out a candidate adjustment strategy with a highest second regulation effect and determines the candidate adjustment strategy as a final bandwidth adjustment parameter.

In some embodiments of the present disclosure, by generating the candidate adjustment strategy, the first regulation effect of each of the plurality of channels is determined by combining the backlog data, load data, and the priority of the data frame and using the effect prediction model, the second regulation effect is further obtained, and an optimal bandwidth adjustment parameter is finally selected. The present disclosure can predict and evaluate the effect of the candidate adjustment strategy before the candidate adjustment strategy is executed, avoids inferior strategies that are prone to cause network congestion in advance, and balances utilization of channel resources and low transmission latency with a mechanism of prediction first and decision later, thereby achieving global optimal scheduling in a complex network environment.

FIG. 6 is a schematic diagram illustrating a bandwidth prediction model according to some embodiments of the present disclosure.

In some embodiments, the management platform is further configured to: determine a predicted bandwidth requirement of a channel through a bandwidth prediction model 620 according to a historical traffic sequence 611 of the channel, the load data 511, and a service type 612, the bandwidth prediction model 620 being a machine learning model; determine a future adjustment parameter 640 according to the predicted bandwidth requirement 630; and generate a second adjustment instruction 650 according to the future adjustment parameter 640, the second adjustment instruction 650 including a transmission bandwidth of the channel at a future moment.

More descriptions regarding the load data may be found in FIG. 2 and related descriptions. More descriptions regarding the predicted bandwidth requirement may be found in FIG. 5 and related descriptions.

The historical traffic sequence refers to a traffic sequence of the channel within a historical time period.

In some embodiments, the historical traffic sequence may be obtained by the management platform 110 extracting a count of data frames of each channel within a historical time period and arranging the count of data frames in a chronological order into the historical traffic sequence.

The service type refers to a type of service for which the channel is responsible for transmission. For example, the service type may include a high-frequency feedback service of a torque sensor of the robotic arm, a low-frequency reporting service of robotic arm position monitoring, a transmission service of system status logs, or other robotic arm operation services.

In some embodiments, the management platform 110 may directly obtain the service type by querying a business system.

In some embodiments, the management platform 110 may determine the predicted bandwidth requirement of the channel through the bandwidth prediction model according to the historical traffic sequence of the channel, load data, and the service type.

The bandwidth prediction model may be the machine learning model. For example, the bandwidth prediction model may be a long short-term memory (LSTM) network, or other custom model structures, or any combination thereof.

In some embodiments, an input of the bandwidth prediction model may include the historical traffic sequence, load data, and the service type. An output of the bandwidth prediction model may include the predicted bandwidth requirement.

A second training sample and a second training label may be obtained based on historical data. Each second training sample may include the historical traffic sequence of a historical time period, historical load data, and a historical service type. A corresponding second training label may include an actual predicted bandwidth requirement corresponding to the second training sample.

In some embodiments, the bandwidth prediction model may be obtained by training based on a large number of second training samples with second training labels. The management platform 110 may input a plurality of second training samples with second training labels into an initial bandwidth prediction model, construct a loss function based on the second training labels and results of the initial bandwidth prediction model, and iteratively update parameters of the initial bandwidth prediction model based on the loss function through a manner such as gradient descent. When the loss function satisfies a preset training condition, a trained bandwidth prediction model is obtained. The preset training condition may include convergence of the loss function, a count of iterations reaching a threshold, or the like.

In some embodiments, the bandwidth prediction model may be jointly trained with the effect prediction model, or the bandwidth prediction model may be trained separately. More descriptions regarding the effect prediction model may be found in FIG. 5 and related descriptions.

In some embodiments, the management platform 110 may filter out target time periods during which stable and fault-free operation is maintained within a preset time window based on historical operation logs of the system, extract actual transmission bandwidths of each channel within the target time periods, determine the actual transmission bandwidths as second training labels corresponding to second training samples; simultaneously, the management platform 110 may obtain traffic sequences, load data, and service types of all channels within a time period (e.g., one hour) before the target time period, and combine these data to construct second training samples.

The future adjustment parameter refers to a bandwidth adjustment parameter at a future moment. For example, the future adjustment parameter may be “a transmission bandwidth of channel A at T+15 min (i.e., 15 minutes after a current moment) is 15 Mbps (the 15 Mbps is the bandwidth adjustment parameter)”, “a transmission bandwidth of channel B at T+15 min is 9 Mbps (the 9 Mbps is the bandwidth adjustment parameter)”, or the like.

In some embodiments, the management platform 110 may determine the future adjustment parameter according to the predicted bandwidth requirement. One future adjustment parameter corresponds to all channels.

For example, the management platform 110, for each channel, multiplies a predicted bandwidth requirement of the channel output by the bandwidth prediction model by a preset redundancy coefficient (e.g., 1.1, 1.2, etc.) to obtain an expected bandwidth quota of the channel at the future moment.

The redundancy coefficient refers to a coefficient introduced to cope with a minor deviation of the predicted bandwidth requirement, and the redundancy coefficient is used to avoid channel congestion caused by a low predicted bandwidth requirement. The minor deviation refers to a small difference between the predicted bandwidth requirement output by the bandwidth prediction model and a real bandwidth requirement actually generated by the channel in the future. For example, the bandwidth prediction model predicts that a certain channel requires 10 Mbps in the future, and an actual requirement is 10.5 Mbps; and a difference of 0.5 Mbps is the minor deviation. The low predicted bandwidth requirement refers to the predicted bandwidth requirement being less than the real bandwidth requirement.

Subsequently, taking one future moment as an example, the management platform 110 calculates a sum of expected bandwidth quotas of all channels at the future moment (i.e., a total requirement), compares the total requirement with a total bandwidth upper limit of a physical link of an edge computing device; if the total requirement is less than or equal to the total bandwidth upper limit, the management platform 110 directly determines an expected bandwidth quota of each channel as the future adjustment parameter of the channel.

If the total requirement is greater than the total bandwidth upper limit, the management platform 110 prioritizes satisfying expected bandwidth quotas of channels related to a robotic arm operation service according to service types; subtracts a total requirement of channels related to the robotic arm operation service from the total bandwidth upper limit, and obtains a difference, which is a remaining available bandwidth. The management platform 110, for channels of other service types, allocates the remaining available bandwidth according to proportions of expected bandwidth quotas of the channels of the other service types to obtain corrected expected bandwidth quotas of the channels of the other service types.

A proportion of the expected bandwidth quota of the channel of the other service types refers to a ratio of the expected bandwidth quota of a single channel among the channels of the other service types to a sum of expected bandwidth quotas of all channels of the other service types.

The management platform 110 combines expected bandwidth quotas of channels related to the robotic arm operation service and corrected expected bandwidth quotas of channels of the other service types to obtain one future adjustment parameter covering all channels at a single future moment. The management platform 110 then performs the above operations for other future moments respectively to obtain a plurality of future adjustment parameters.

The second adjustment instruction refers to an instruction for controlling channel bandwidth configuration. In some embodiments, the second adjustment instruction includes a transmission bandwidth of the channel at a future moment. For example, the second adjustment instruction may include “when the current time reaches T+15 min (15 minutes after a current moment), immediately adjust the transmission bandwidth of channel A to 15 Mbps, and simultaneously adjust the transmission bandwidth of channel B to 9 Mbps”, or the like.

In some embodiments, the management platform 110 generates a control instruction with time-series triggering characteristics based on the future adjustment parameter and uses the control instruction as the second adjustment instruction.

In some embodiments of the present disclosure, through analysis of the historical traffic sequence of the channel, load data, and service type by the bandwidth prediction model (e.g., a Long Short-Term Memory (LSTM) model), the predicted bandwidth requirement is accurately determined, the future adjustment parameter is further determined, and the second adjustment instruction is generated, thereby achieving proactive bandwidth control. The present disclosure shifts from post-congestion management to pre-congestion prevention and reserves a transmission channel of the channel at a millisecond level before arrival of a traffic peak, thereby eliminating an instantaneous packet loss phenomenon caused by lag in bandwidth adjustment.

The basic concepts have been described above. Obviously, to a person skilled in the art, the detailed disclosure above is merely an example and does not constitute a limitation on the present disclosure. Although not explicitly stated herein, a person skilled in the art may make various modifications, improvements, and amendments to the present disclosure. Such modifications, improvements, and amendments are suggested in the present disclosure, so such modifications, improvements, and amendments still fall within the spirit and scope of the exemplary embodiments of the present disclosure.

Meanwhile, the present disclosure uses specific words to describe the embodiments of the present disclosure. For example, “an embodiment”, “one embodiment”, and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

In addition, unless explicitly stated in the claims, the order of processing elements and sequences, the use of numbers and letters, or the use of other names described in the present disclosure is not intended to limit the order of processes and methods of the present disclosure. Although the foregoing disclosure discusses some inventive embodiments currently considered useful through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the implementation of various components described above may be embodied in a hardware device, it may also be implemented as a software only solution, e.g., an installation on an existing server or mobile device.

Similarly, it should be noted that, in order to simplify the expression disclosed in the present disclosure to help understand one or more inventive embodiments, sometimes multiple features are grouped into one embodiment, drawing, or description thereof in the foregoing description of the embodiments of the present disclosure. However, this disclosure method does not mean that the object of the present disclosure requires more features than those mentioned in the claims. Rather, claimed subject matter may lie in less than all features of a single foregoing disclosed embodiment.

Finally, it should be understood that the embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A system for collaborative transmission of sensor data based on Internet of Things, comprising a management platform and a perception and control platform, wherein the management platform is configured to:
determine a data type of a data frame according to a header parameter of the data frame;
determine a priority of the data frame according to the data type, an expiration time, and an information entropy;
determine a bandwidth adjustment parameter according to load data of a channel, backlog data of a priority queue, and the priority of the data frame; and
generate a first adjustment instruction according to the bandwidth adjustment parameter, and send the first adjustment instruction to the perception and control platform;
wherein the perception and control platform includes an edge computing device, and the edge computing device is configured to:
adjust a transmission bandwidth of the channel based on the first adjustment instruction.

2. The system of claim 1, wherein the management platform is further configured to:
execute a preprocessing operation on the data frame according to the data type to determine the priority queue corresponding to the data frame.

3. The system of claim 2, wherein the preprocessing operation includes a first preprocessing and a second preprocessing, and the management platform is further configured to:
when the data type of the data frame is a control instruction, execute the first preprocessing on the data frame; wherein the first preprocessing includes: bypassing a buffer module and a compression module, so that the data frame directly enters a high-priority queue; and
when the data type of the data frame is perception data, execute the second preprocessing on the data frame; wherein the second preprocessing includes: performing lossless compression on the data frame by using a preset compression algorithm, so that the data frame enters a low-priority queue.

4. The system of claim 1, wherein the management platform is further configured to:
determine an acquisition parameter according to the load data and the backlog data;
generate an acquisition instruction according to the acquisition parameter, and send the acquisition instruction to the perception and control platform; wherein the acquisition parameter includes a sampling frequency and an upload frequency; and
control a sensor to perform data acquisition at the sampling frequency based on the acquisition instruction, and upload acquired data to the edge computing device at the upload frequency.

5. The system of claim 1, wherein the management platform is further configured to:
generate a candidate adjustment strategy;
determine a first regulation effect corresponding to the candidate adjustment strategy through an effect prediction model according to the load data, the backlog data, the priority of the data frame, and the candidate adjustment strategy; wherein the effect prediction model is a machine learning model; each first regulation effect corresponds to one channel;
determine a second regulation effect of the candidate adjustment strategy according to the first regulation effect; and
determine the bandwidth adjustment parameter according to the second regulation effect.

6. The system of claim 5, wherein an input of the effect prediction model further includes a predicted bandwidth requirement of each channel.

7. The system of claim 5, wherein the management platform is further configured to:
determine a weight coefficient of the channel according to a state feature and a task feature of a robotic arm corresponding to the channel; and
determine the second regulation effect according to the weight coefficient and the first regulation effect.

8. The system of claim 1, wherein the management platform is further configured to:
determine a predicted bandwidth requirement of the channel through a bandwidth prediction model according to a historical traffic sequence of the channel, the load data, and a service type;
wherein the bandwidth prediction model is a machine learning model;
determine a future adjustment parameter according to the predicted bandwidth requirement; and
generate a second adjustment instruction according to the future adjustment parameter, wherein the second adjustment instruction includes a transmission bandwidth of the channel at a future moment.

9. A method for collaborative transmission of sensor data based on Internet of Things, implemented based on a management platform, the method comprising:
determining a data type of a data frame according to a header parameter of the data frame;
determining a priority of the data frame according to the data type, an expiration time, and an information entropy;
determining a bandwidth adjustment parameter according to load data of a channel, backlog data of a priority queue, and the priority of the data frame;
generating a first adjustment instruction according to the bandwidth adjustment parameter, and sending the first adjustment instruction to a perception and control platform, wherein the perception and control platform includes an edge computing device; and
adjusting a transmission bandwidth of the channel by the edge computing device based on the first adjustment instruction.

10. The method of claim 9, further comprising:
executing a preprocessing operation on the data frame according to the data type to determine a priority queue corresponding to the data frame.

11. The method of claim 10, wherein the preprocessing operation includes a first preprocessing and a second preprocessing, and the executing a preprocessing operation on the data frame according to the data type to determine a priority queue corresponding to the data frame includes:
when the data type of the data frame is a control instruction, executing the first preprocessing on the data frame; wherein the first preprocessing includes: bypassing a buffer module and a compression module, so that the data frame directly enters a high-priority queue; and
when the data type of the data frame is perception data, executing the second preprocessing on the data frame; wherein the second preprocessing includes: performing lossless compression on the data frame by using a preset compression algorithm, so that the data frame enters a low-priority queue.

12. The method of claim 9, further comprising:
determining an acquisition parameter according to the load data and the backlog data;
generating an acquisition instruction according to the acquisition parameter, and sending the acquisition instruction to the perception and control platform; wherein the acquisition parameter includes a sampling frequency and an upload frequency; and
controlling a sensor to perform data acquisition at the sampling frequency based on the acquisition instruction, and uploading acquired data to the edge computing device at the upload frequency.

13. The method of claim 9, wherein the determining a bandwidth adjustment parameter according to load data of a channel, backlog data of a priority queue, and the priority of the data frame includes:
generating a candidate adjustment strategy;
determining a first regulation effect corresponding to the candidate adjustment strategy through an effect prediction model according to the load data, the backlog data, the priority of the data frame, and the candidate adjustment strategy; wherein the effect prediction model is a machine learning model, and each first regulation effect corresponds to one channel;
determining a second regulation effect of the candidate adjustment strategy according to the first regulation effect; and
determining the bandwidth adjustment parameter according to the second regulation effect.

14. The method of claim 13, wherein an input of the effect prediction model further includes a predicted bandwidth requirement of each channel.

15. The method of claim 13, wherein the determining a second regulation effect of the candidate adjustment strategy according to the first regulation effect includes:
determining a weight coefficient of the channel according to a state feature and a task feature of a robotic arm corresponding to the channel; and
determining the second regulation effect according to the weight coefficient and the first regulation effect.

16. The method of claim 9, further comprising:
determining a predicted bandwidth requirement of the channel through a bandwidth prediction model according to a historical traffic sequence of the channel, the load data, and a service type; wherein the bandwidth prediction model is a machine learning model;
determining a future adjustment parameter according to the predicted bandwidth requirement; and
generating a second adjustment instruction according to the future adjustment parameter, wherein the second adjustment instruction includes a transmission bandwidth of the channel at a future moment.

17. A non-transitory computer-readable storage medium, wherein the storage medium stores computer instructions, and when a computer reads the computer instructions in the storage medium, the computer executes the method according to claim 9.
